(19) United States
(12) Patent Application Publication
(10) Pub. No.: US 2009/0063961 A1
(43) Pub. Date: Mar. 5, 2009

(54) TYPE-AHEAD HINTS WITH DYNAMICALLY CONFIGURABLE USER PREFERENCES

(76) Inventors: Al Chakra, Apex, NC (US); Yuping C. Wu, Cary, NC (US); Yongcheng Li, Cary, NC (US)

Correspondence Address: HOFFMAN WARNICK LLC, 75 STATE ST, 14TH FLOOR, ALBANY, NY, 12207, US

(21) Appl. No.: 11/845,176

(22) Filed: Aug. 27, 2007

(51) Int. Cl. G06F 3/01

(52) U.S. Cl. 715/259

(57) ABSTRACT

An improved solution for dynamically configurable user preferences in a type-ahead hint system is provided. In an embodiment of the invention, a method for providing type-ahead hints includes: receiving an input string; providing a configurable preference interface; obtaining a preference from the interface; and generating at least one type-ahead hint, based upon the input string and the preference.

### FIELD OF THE INVENTION

Aspects of the invention relate generally to type-ahead hints in software systems, and more particularly, to a type-ahead hint system with dynamically configurable user preferences.

### BACKGROUND OF THE INVENTION

Type-ahead hint systems are used to aid users to improve input speed and choose the right word(s) and/or phrases. The type-ahead hint lists drawn from a type-ahead hint system are often voluminous. Users vary greatly in their particular matching desires however. The look-ahead hint (e.g., word, phrase, etc.) first provided by the type-ahead hint system may be entirely accurate for a first user, but nowhere near adequate for a second user. Further, often the same user's desires for hint matchability even varies during different sessions and/or over the course of the same session. As such, the likelihood that the specific input string entered by the user under the type-ahead hint system will provide the “correct”, or desired, type-ahead hint for that particular user during a session is greatly diminished.

In order improve the general quality of the hints provided, some type-ahead hint systems limit the hints to those based on statistics of an entire user population. Amongst other shortcomings, this type of user-wide statistical embellishment can waste additional server resources by providing hints that are rarely selected, thus making it counterproductive.

Accordingly, there is an opportunity to improve upon the effectiveness of type-ahead hint systems.

### BRIEF SUMMARY OF THE INVENTION

Aspects of the invention provide an improved solution in type-ahead hint systems.

A first aspect of the invention provides a method for providing type-ahead hints, the method comprising: receiving an input string; providing a configurable preference interface; obtaining a preference from the interface; and generating at least one type-ahead hint, based upon the input string and the preference.

A second aspect of the invention provides a system for providing type-ahead hints, the system comprising: a module for receiving an input string; a module for providing a configurable preference interface; a module for obtaining a preference from the interface; and a module for generating at least one type-ahead hint, based upon the input string and the preference.

A third aspect of the invention provides a computer program comprising program code stored on a computer-readable medium, which when executed, enables a computer system to implement a method for providing type-ahead hints, the method comprising: receiving an input string; providing a configurable preference interface; obtaining a preference from the interface; and generating at least one type-ahead hint, based upon the input string and the preference.

A fourth aspect of the invention provides a method of generating a system for providing type-ahead hints, the method comprising: providing a computer system operable to: receive an input string; provide a configurable preference interface; obtain a preference from the interface; and generate at least one type-ahead hint, based upon the input string and the preference.

A fifth aspect of the invention provides a data processing system for providing type-ahead hints, comprising: a processing unit; a bus coupled to the processing unit; and a memory medium coupled to the bus comprising program code, which when executed by the processing unit causes the data processing system to: receive an input string; provide a configurable preference interface; obtain a preference from the interface; and generate at least one type-ahead hint, based upon the input string and the preference.

A sixth aspect of the invention provides computer software embodied in at least one propagated signal for providing type-ahead hints, the at least one propagated signal comprising instructions for causing at least computer system to: receive an input string; provide a configurable preference interface; obtain a preference from the interface; and generate at least one type-ahead hint, based upon the input string and the preference.

A seventh aspect of the invention provides a business method for managing a method for providing type-ahead hints, the business method comprising: managing a network that includes at least one computer system that performs the process described herein; and receiving payment based on the managing.

The illustrative aspects of the invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 shows an illustrative environment for employing dynamically configurable user preferences in a type-ahead hint system according to an embodiment of the invention.

FIG. 2 shows a schematic diagram wherein the environment shown in FIG. 1 may be employed according to an embodiment of the invention.

FIGS. 3A-3C show various illustrative user interfaces that may be produced by the environment in FIG. 1 according to embodiments of the invention.

It is noted that the drawings are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

As indicated above, aspects of the invention provide an improved solution for type-ahead hint systems. In an embodiment of the invention, a method for providing type-ahead hints comprises: receiving an input string; providing a configurable preference interface; obtaining a preference from the interface; and generating at least one type-ahead hint, based upon the input string and the preference. As used herein, unless otherwise noted, the term “set” means one or more (i.e., at least one); the term “input string” means, in any quantity, a symbol, letter, numeral, and/or combinations thereof; and the phrase “any solution” means any now known or later developed solution.

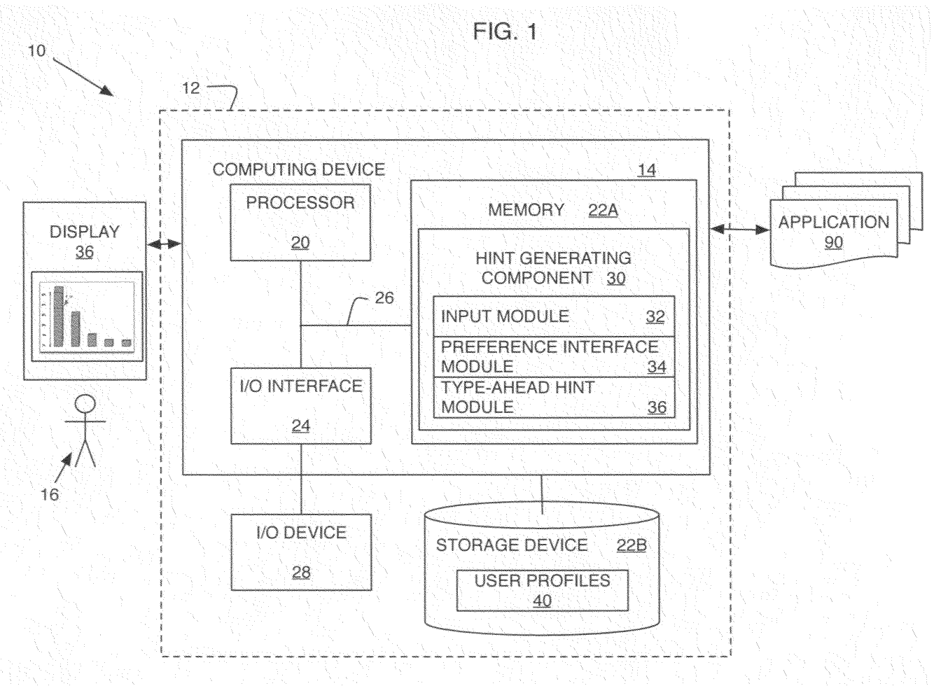

Turning to the drawings, FIG. 1 shows an illustrative environment 10 for providing dynamically configurable user preferences in a type-ahead hint system according to an embodiment of the invention. To this extent, environment 10 includes a computer system 12 that can perform the process described herein in order to provide dynamically configurable user preferences in a type-ahead hint system. In particular, computer system 12 is shown including a computing device 14 that comprises a hint generating component 30, which makes computing device 14 operable to provide dynamically configurable user preferences in a type-ahead hint system, by performing the process described herein.

Computing device 14 is shown including a processor 20, a memory 22A, an input/output (I/O) interface 24, and a bus 26. Further, computing device 14 is shown in communication with an external I/O device/resource 28 and a storage device 22B. In general, processor 20 executes program code, such as hint generating component 30, which is stored in a storage system, such as memory 22A and/or storage device 22B. While executing program code, processor 20 can read and/or write data, such as user profile(s) 40, etc. to/from memory 22A, storage device 22B, and/or I/O interface 24. Bus 26 provides a communications link between each of the components in computing device 14. I/O device 28 can comprise any device that transfers information between a user 16 and computing device 14 and/or other elements and computing device 14. To this extent, I/O device 28 can comprise a user I/O device to enable an individual user 16 to interact with computing device 14 and/or a communications device to enable an element (e.g., display 36) to communicate with computing device 14 using any type of communications link.

In any event, computing device 14 can comprise any general purpose computing article of manufacture capable of executing program code installed thereon. However, it is understood that computing device 14 and hint generating component 30 are only representative of various possible equivalent computing devices that may perform the process described herein. To this extent, in other embodiments, the functionality provided by computing device 14 and hint generating component 30 can be implemented by a computing article of manufacture that includes any combination of general and/or specific purpose hardware and/or program code. In each embodiment, the program code and hardware can be created using standard programming and engineering techniques, respectively.

Similarly, computer system 12 is only illustrative of various types of computer systems for implementing aspects of the invention. For example, in one embodiment, computer system 12 comprises two or more computing devices that communicate over any type of communications link, such as a network, a shared memory, or the like, to perform the process described herein. Further, while performing the process described herein, one or more computing devices in computer system 12 can communicate with one or more other computing devices external to computer system 12 using any type of communications link. In either case, the communications link can comprise any combination of various types of wired and/or wireless links; comprise any combination of one or more types of networks; and/or utilize any combination of various types of transmission techniques and protocols.

As discussed herein, hint generating component 30 enables computer system 12 to provide dynamically configurable user preferences in a type-ahead hint system. To this extent, hint generating component 30 is shown including an input module 32, a preference interface module 34, and a type-ahead hint module 36. Operation of each of these modules is discussed further herein. However, it is understood that some of the various modules shown in FIG. 1 can be implemented independently, combined, and/or stored in memory of one or more separate computing devices that are included in computer system 12. Further, it is understood that some of the modules and/or functionality may not be implemented, or additional modules and/or functionality may be included as part of computer system 12.

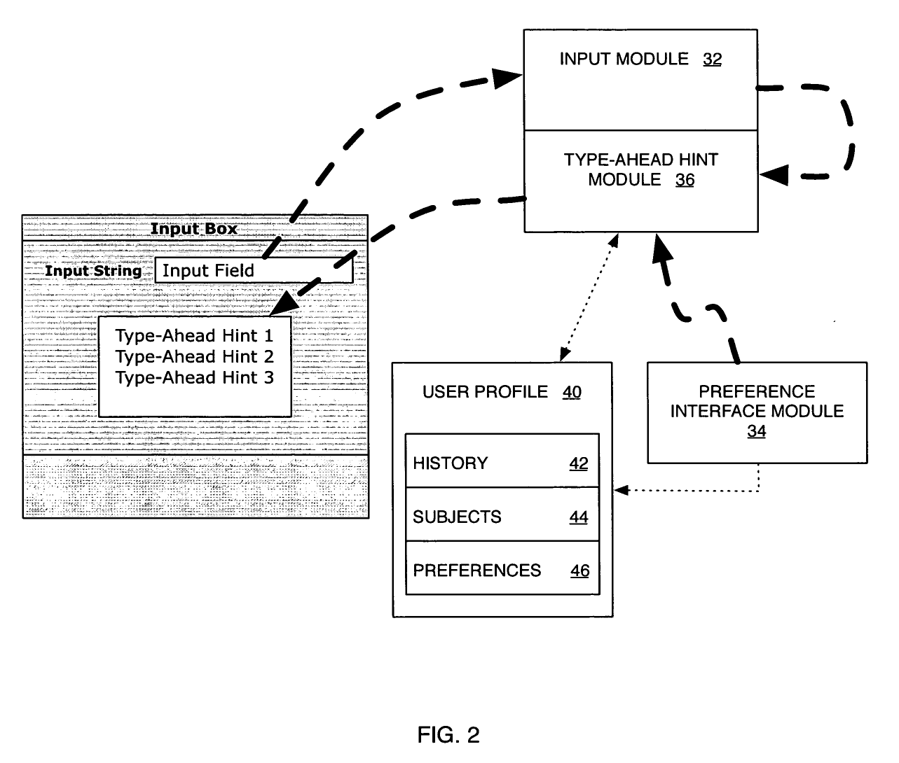

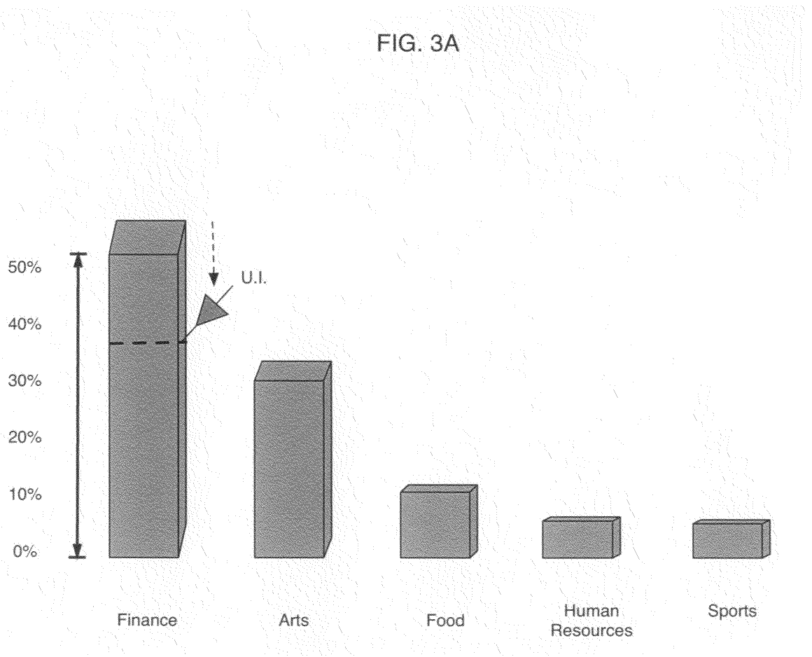

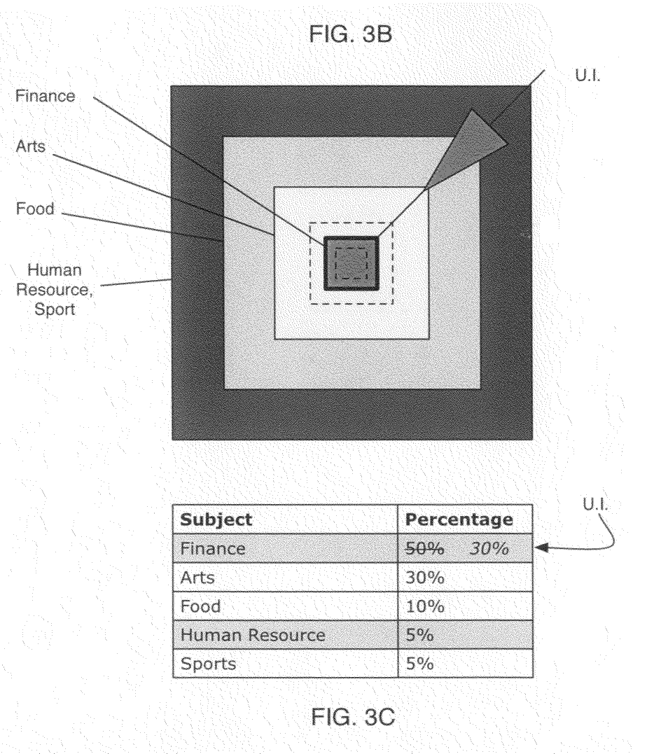

Aspects of the invention provide an improved solution for type-ahead hint systems that employs dynamically configurable user preferences in a type-ahead hint system. To this extent, FIGS. 2 through 3C show various scenarios and aspects that may be employed by the computer system 12 of FIG. 1, according to embodiments of the invention. For example, a user 16 may wish to receive type-ahead hints on a display 36 when accessing an application 90 (FIG. 1) for any purpose. In so doing, the user 16 can benefit by utilizing aspects of the present invention. The application 90 may be any now known or later developed application that can benefit from the use of a type-ahead hint system. For example, the application 90 may be an application for use on the Internet (e.g., for conducing a web search); for searching PDF documents; a text editor; for searching within an operating system; for searching any searchable file; and/or the like.

Aspects of the invention allow the computer system 12 employing the hint generating component 30 to dynamically configure user preferences. As a result, accurate and more useful (e.g., matchable) type-ahead hints are generated for the user. Ultimately, time and system throughputs are saved. Referring to FIG. 2, a user 16 may enter an input string, in for example the “Input Field”. In reponse to the input module 32 receiving the input string, the hint list module 36 generates at least one type-ahead hint based upon the input string. As depicted in FIG. 2 three type-ahead hints are provided (e.g., “Type-Ahead Hint 1”, “Type-Ahead Hint 2”, “Type-Ahead Hint 3”). The type-ahead hint and/or the type-ahead hint list, from which the hint(s) derived from are based upon the input string and a preference 46.

The preference interface module 34 may interact with both the input module 32, the type-ahead hint module 36, and/or the user profile 40. The preference interface module 34 provides a configurable preference interface (CPI) to the user 16 (FIG. 1). The preference interface module 34 obtains at least one preference from the CPI. The CPI may be invoked to appear in a graphical user interface (GUI) only upon a user's selection; or the CPI may be present (e.g., on screen) at all times; and/or the CPI may appear only upon certain specific activity(ies) by the user (e.g., entering an input string entirely outside the user profile 40). In this manner because the generated type-ahead hint is based, at least in part, upon the preference(s), the hint(s) provided may be weighted accordingly. By way of example only, if a user 16 is an accountant, then based on preferences, the type-ahead hints for this user 16 more likely may include hints in the arena of the accounting; conversely, if another user 16 is an artist, then based on his/her particular preferences, the type-ahead hints for this user 16 are more likely to include hints in the arena of the arts.

Various examples of the CPIs in a graphical user interface (GUI) setting, provided by the preference interface module 34 are shown in FIGS. 3A-3C. CPI allows a user 16 provide a preference and/or to check and dynamically adjust his/her user profile 40. Clearly, the user 16 can adjust the profile 40 for the instant search session, as well as make temporary, long-term, and/or permanent adjustments as desired.

The three examples provided depict preferences for certain subjects 44 for the same hypothetical user 16. The user 16 has the greatest interest in the subject of finance; a second interest in the arts; a moderate interest in food; and the least interest of the five categories in human resources and sports. Referring to FIG. 3A, which depicts a bar chart, wherein a user 16 could adjust the interest percentages similarly by dragging a user interface (U.I.) upward or downward (as shown) to connote a greater, or lesser, interest, respectively in a particular subject 44. In this manner a user 16 is able to edit or customize dynamically his/her preferences so as to ultimately adjust the type-ahead hint list(s) and type-ahead hint(s) provided by the type-ahead hint module 36 (FIG. 2).

Similarly, FIG. 3B depicts a bull's-eye type configuration of the CPI depicting the same percentages of interest. For example, “Finance” being at the center of the “bull” connotes the greatest interest. Similarly, “Human Resource” and “Sports”, being at the periphery connote the least interest by the user 16. The user 16 could adjust the interest percentages by, for example, “clicking” and “dragging” the edges of the various circles larger or smaller and/or remove them entirely to adjust the preference percentages.

FIG. 3C depicts a CPI in tabular format wherein the user 16 is 50% interested in “Finance”; 30% interested in “Arts”; 10% interested in “Food”; 5% interested in “Human Resources”; and, 5% interested in “Sports”. The user 16, for example, for one session could adjust the interest to 100% (i.e., all interest) into “Finance”. Alternatively, as shown the user 16 may lower the interest in Finance from 50% to 30%. Ultimately, this on-the-fly capability of altering preferences allows the user 16 to edit and configure the type-ahead hints provided.

Returning to FIG. 2, in another embodiment the type-ahead hint module 36 is able to generate, update, obtain data from, and maintain user profiles 40. In this manner, the user profiles 40 may include a history 42 (e.g., statistics) of any activity by the user 16 related to the type-ahead hint system. The user profile 40 may include subjects 44 that the user 16 is interested in. Alternatively, the subjects 44 may be items in which the user 16 has entirely no interest. For example, a parent may opt to have a child's preference list avoid certain subject matter. The user profile 40 may further include preferences 46 which may be based on history 42 (e.g., actual hint selections) and/or various responses, edits and inputs provided at the CPI.

In another embodiment, the invention provides a computer program stored on a computer-readable medium, which when executed, enables a computer system to provide dynamically configurable user preferences in a type-ahead hint system. To this extent, the computer-readable medium includes program code, such as hint generating component 30 (FIG. 1), which implements the process described herein. It is understood that the term “computer-readable medium” comprises one or more of any type of tangible medium of expression capable of embodying a copy of the program code (e.g., a physical embodiment). In particular, the computer-readable medium can comprise program code embodied on one or more portable storage articles of manufacture, on one or more data storage portions of a computing device, such as memory 22A (FIG. 1) and/or storage system 22B (FIG. 1), as a data signal traveling over a network (e.g., during a wired/wireless electronic distribution of the computer program), on paper (e.g., capable of being scanned and converted to electronic data), and/or the like.

In another embodiment, the invention provides a method of generating a system for providing dynamically configurable user preferences in a type-ahead hint system. In this case, a computer system, such as computer system 12 (FIG. 1), can be obtained (e.g., created, maintained, having made available to, etc.) and one or more programs/systems for performing the process described herein can be obtained (e.g., created, purchased, used, modified, etc.) and deployed to the computer system. To this extent, the deployment can comprise one or more of: (1) installing program code on a computing device, such as computing device 14 (FIG. 1), from a computer-readable medium; (2) adding one or more computing devices to the computer system; and (3) incorporating and/or modifying one or more existing devices of the computer system, to enable the computer system to perform the process described herein.

In still another embodiment, the invention provides a business method that manages a method for providing dynamically configurable user preferences in a type-ahead hint system, which enables users to perform the process described herein on a subscription, advertising, and/or fee basis. That is, a service provider could offer to manage a network and/or a computer system 12 (FIG. 1) that provides dynamically configurable user preferences in a type-ahead hint system as described herein. In this case, the service provider can manage (e.g., create, maintain, support, etc.) a virtual and/or physical network that enables users to communicate content using computer systems, such as computer system 12, that perform the process described herein. In return, the service provider can receive payment from the user(s) under a subscription and/or fee agreement, receive payment from the sale of advertising to one or more third parties, and/or the like.

As used herein, it is understood that “program code” means any set of statements or instructions, in any language, code or notation, that cause a computing device having an information processing capability to perform a particular function either directly or after any combination of the following: (a) conversion to another language, code or notation; (b) reproduction in a different material form; and/or (c) decompression. To this extent, program code can be embodied as any combination of one or more types of computer programs, such as an application/software program, component software/a library of functions, an operating system, a basic I/O system/driver for a particular computing, storage and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

What is claimed is:

1. A method for providing type-ahead hints, the method comprising:
receiving an input string;
providing a configurable preference interface;
obtaining a preference from the interface; and
generating at least one type-ahead hint, based upon the input string and the preference.

2. The method of claim 1, wherein the configurable preference interface is configurable by at least one of a user or a user profile.

3. The method of claim 1, further comprising generating a user profile.

4. The method of claim 3, wherein the user profile is based upon a history of the user.

5. The method of claim 3, further comprising rendering the user profile on a graphical user interface (GUI).

6. The method of claim 1, wherein the providing the configurable preference interface further includes providing a graphical user interface (GUI) configured to allow edits to at least one of a user profile or the preference.

7. The method of claim 1, further comprising at least one of:
determining a subject of the input string; or
adjusting the configurable preference interface, based on the subject.

8. The method of claim 1, wherein the input string is received from a web search application.

9. The method of claim 1, wherein the configurable preference interface includes a plurality of categories.

10. A system for providing type-ahead hints, the system comprising:
a module for receiving an input string;
a module for providing a configurable preference interface;
a module for obtaining a preference from the interface; and
a module for generating at least one type-ahead hint, based upon the input string and the preference.

11. The system of claim 10, wherein the configurable preference interface is configurable by at least one of a user or a user profile.

12. The system of claim 10, wherein the module for generating further comprises a module for rendering the user profile on a graphical user interface (GUI).

13. A computer program comprising program code stored on a computer-readable medium, which when executed, enables a computer system to implement a method for providing type-ahead hints, the method comprising:
receiving an input string;
providing a configurable preference interface;
obtaining a preference from the interface; and
generating at least one type-ahead hint, based upon the input string and the preference.

14. The computer program of claim 13, wherein the configurable preference interface is configurable by at least one of a user and a user profile.

15. The computer program of claim 13, wherein the method further comprises generating a user profile.

16. The computer program of claim 15, wherein the user profile is based upon a history of the user.

17. The computer program of claim 15, wherein the method further comprises rendering the user profile on a graphical user interface (GUI).

18. The computer program of claim 13, wherein the providing the configurable preference interface further includes providing a graphical user interface (GUI) configured to allow edits to at least one of a user profile or the preference.

19. The computer program of claim 13, wherein the method further comprises at least one of:
determining a subject of the input string; or
adjusting the configurable preference interface, based on the subject.

20. The computer program of claim 13, wherein the input string is received from a web search application.
